(19) United States
(12) Patent Application Publication
(10) Pub. No.: US 2025/0130413 A1
(43) Pub. Date: Apr. 24, 2025

(54) AUGMENTED REALITY DISPLAY INTEGRATED WITH MICROSCOPE OCULARS

(71) Applicant: Vanderbilt University, Nashville, TN (US)

(72) Inventors: Yuankai Tao, Nashville, TN (US); Samantha Morganti, Nashville, TN (US); Jacob Watson, Nashville, TN (US); Rachel Hecht, Nashville, TN (US)

(21) Appl. No.: 18/916,317

(22) Filed: Oct. 15, 2024

Related U.S. Application Data
(60) Provisional application No. 63/591,878, filed on Oct. 20, 2023.

(51) Int. Cl. G02B 21/06; G02B 5/08; G02B 5/20

(52) U.S. Cl. CPC G02B 21/06; G02B 5/08; G02B 5/20

(57) ABSTRACT

Methods and apparatus for generating intraocular overlay patterns in an optical microscope. In one example, an intraocular overlay pattern is generated using a digital micromirror device located in the intermediate focal plane of a telecentric optical relay coupled between the objective lens and an eyepiece of the optical microscope. In some examples, the overlay pattern displays real-time visualization of intraoperative optical coherence tomography data and surgical field overlays. Such overlay patterns can beneficially be used, e.g., to provide real-time intraoperative feedback during ophthalmic surgery substantially without any interference with the surgical workflow.

### CROSS-REFERENCE TO RELATED APPLICATIONS

This application claims the benefit of U.S. Provisional Patent Application No. 63/591,878 filed Oct. 20, 2023, and entitled “SYSTEMS AND METHODS FOR AUGMENTED/MIXED REALITY DISPLAY USING DIGITAL MICROMIRROR DEVICE,” the contents of which are incorporated herein by reference.

### STATEMENT REGARDING FEDERALLY SPONSORED RESEARCH

This invention was made with government support under EY030490, EY031769, and EY033969 awarded by the National Institutes of Health. The government has certain rights in the invention.

### FIELD OF THE DISCLOSURE

Various example embodiments relate to visual displays and, more specifically but not exclusively, to augmented reality displays for imaging applications.

### BACKGROUND

Augmented reality (AR) refers to real-time integration of digital information into a user's environment. In some examples, AR technology is used to overlay additional content, such as graphics, images, and/or text, onto the real-world view observed by the user, thereby enriching the user's perception of reality rather than replacing it. With AR, users still see and can interact with the corresponding physical environments while experiencing supplementary information overlaid onto their field of vision. Various AR technologies are beneficially used, e.g., in retail shopping, education, manufacturing, entertainment, healthcare, and navigation.

### SUMMARY

Various examples provide methods and apparatus for generating intraocular overlay patterns in an optical microscope. In one example, an intraocular overlay pattern is generated using a digital micromirror device (DMD) located in the intermediate focal plane of a telecentric optical relay coupled between the objective lens and an eyepiece of the optical microscope. In some examples, the overlay pattern displays real-time visualization of intraoperative optical coherence tomography (iOCT) data and surgical field overlays. Such overlay patterns can beneficially be used, e.g., to provide real-time intraoperative feedback during ophthalmic surgery substantially without any interference with the surgical workflow.

In one example, an optical microscope comprises: a first optical relay coupled between an objective lens and a first eyepiece of the optical microscope, the first optical relay having an intermediate focal plane between first and second relay portions thereof; a first two-dimensional (2D) mirror array having at least a first portion thereof in the intermediate focal plane of the first optical relay; a light source configured to illuminate the first 2D mirror array with overlay light; and a driver circuit configured to controllably switch each mirror of the first 2D mirror array between a respective first orientation and a respective second orientation. In the respective first orientation, a mirror of the first 2D mirror array is configured to: direct object light from the objective lens toward the first eyepiece; and direct the overlay light from the light source toward a light trap. In the respective second orientation, the mirror of the first 2D mirror array is configured to: direct the object light from the objective lens toward the light trap; and direct the overlay light from the light source toward the first eyepiece.

In another example, a method of generating an intraocular overlay pattern in an optical microscope comprises illuminating a 2D mirror array with overlay light, the 2D mirror array having at least a portion thereof in an intermediate focal plane of an optical relay coupled between an objective lens and an eyepiece of the optical microscope; and controllably rotating each mirror of the 2D mirror array into a respective first orientation or a respective second orientation. In the respective first orientation, a mirror of the 2D mirror array is configured to: direct object light from the objective lens toward the eyepiece; and direct the overlay light toward a light trap. In the respective second orientation, the mirror of the 2D mirror array is configured to: direct the object light from the objective lens toward the light trap; and direct the overlay light toward the eyepiece.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating an optical microscope according to some examples.

FIGS. 2A-2B are block diagrams illustrating optical configurations of a two-dimensional (2D) mirror array used in the optical microscope of FIG. 1 according to some examples.

FIGS. 3A-3B are block diagrams illustrating a volumetric imaging module coupled to the optical microscope of FIG. 1 according to some examples.

FIGS. 4A-4C pictorially illustrate volumetric imaging data acquired with the volumetric imaging module of FIG. 3A according to one example.

FIG. 5 pictorially illustrates an intraocular view observed at an eyepiece of the optical microscope of FIG. 1 according to one example.

FIGS. 6A-6C illustrate overlay contrast improvements achieved with the optical microscope of FIG. 1 according to some examples.

FIG. 7 is a block diagram illustrating a computing device used in or connected to the optical microscope of FIG. 1 according to some examples.

### DETAILED DESCRIPTION

In the following description, numerous details are set forth, such as optical device/system configurations, timings, operations, and the like, in order to provide an understanding of one or more aspects of the present disclosure. It will be readily apparent to persons of ordinary skill in the pertinent art that these specific details are mere examples and are not intended to limit the scope of this application.

An operating or surgical microscope is an optical microscope specifically designed for use in a surgical setting, usually to assist with microsurgery. Typical magnification provided by a surgical microscope is in the approximate range from 4× to 40×. Certain components of the surgical microscope may be specifically designed for relatively easy sterilization or disinfection to ensure good cross-infection control. In some examples, a surgical microscope may incorporate a prism that allows splitting of the pertinent light beam, e.g., to enable the surgeon's assistant to also visualize the procedure or to allow photography or videography of the surgical field to be performed substantially without any interference with the surgical procedure. In some examples, a surgical microscope may incorporate optics that enables intraoperative optical coherence tomography (iOCT) to be performed during the procedure. Fields of medicine that make significant use of surgical microscopes include plastic surgery, dentistry (e.g., endodontics), otolaryngology (or ENT) surgery, ophthalmic surgery, and neurosurgery.

Microscope-integrated iOCT allows for depth-resolved volumetric imaging during surgery. In some examples, real-time visualization of iOCT data may be displayed on an external monitor (e.g., a computer or True Vision display) or a heads-up display (HUD) coupled to the microscope. In such examples, stereoscopic surgical views are either completely lost or necessitate the use of polarization glasses to be observable on the external monitor. In some other examples, an intraocular HUD may couple Light-Emitting-Diode (LED) or Organic Light-Emitting-Diode (OLED) displays across a beamsplitter cube to overlay the iOCT data onto the surgical views. However, in such examples, the display contrast may be limited by a relatively low panel brightness and/or tradeoffs between the display and surgical field brightness. In addition, to be sufficiently perceptible, the overlays may need to be generally constrained to dark or unused regions of the surgical field of view (FOV).

At least some of the above-indicated problems in the state of the art can beneficially be addressed using various embodiments disclosed herein. In one example, a surgical microscope includes an optical relay coupled between an objective lens and an eyepiece of the microscope, a two-dimensional (2D) micromirror array in the intermediate focal plane of the optical relay, a light source configured to illuminate the 2D micromirror array with overlay light, and an electronic controller configured to controllably switch each micromirror in the 2D micromirror array between a respective first orientation and a respective second orientation. In the respective first orientation, a micromirror of the 2D micromirror array is configured to direct object light from the objective lens toward the eyepiece and direct the overlay light from the light source toward a light trap. In the respective second orientation, the micromirror is configured to direct the object light from the objective lens toward the light trap and direct the overlay light from the light source toward the eyepiece. The electronic controller operates to control orientations of individual micromirrors in the 2D micromirror array to cause a desired overlay pattern (e.g., iOCT graphics, surgical-field markers, text, etc.) to be projected by the 2D micromirror array toward the eyepiece of the microscope together with the complimentary portion of the real-time view of the surgical FOV.

In some examples, the 2D micromirror array can be implemented using a commercially available digital micromirror device (DMD), such as the Model DLP471TP DMD from Texas Instruments. In some examples, the surgical microscope additionally includes one or more of the following features: binocular support using separate dedicated DMDs for each ocular or a shared DMD for both oculars; stereoscopic overlay using differential ray casting displays for each ocular; more precise color control and fidelity by modulating the corresponding RGB LED source and DMD on/off synchronously or asynchronously; polarization switching to multiplex information, thereby effectively doubling the information throughput; and use of the DMD(s) in conjunction with pixel shifters to increase pixel density (e.g., at the expense of pixel rates).

In some examples, a similar optical design can be used in optical devices other than surgical microscopes, such as in various augmented/mixed reality viewing devices for medical and educational applications.

As used herein, the term “real time” refers to a computer-based process that controls or monitors a corresponding environment by receiving data, processing the received data, and generating a response sufficiently quickly to affect or characterize the environment without significant delay. In the context of control or processing software, real-time responses are often understood to be on the order of milliseconds, or sometimes microseconds. In the context of a surgical procedure, “real-time” updates mean that the experimental data and measurement results derived therefrom sufficiently accurately represent the state of the surgical FOV at any point in time. In this case, data-acquisition and/or processing delays of several seconds may still be considered to be within “real time” or “near real time” for at least some surgical procedures.

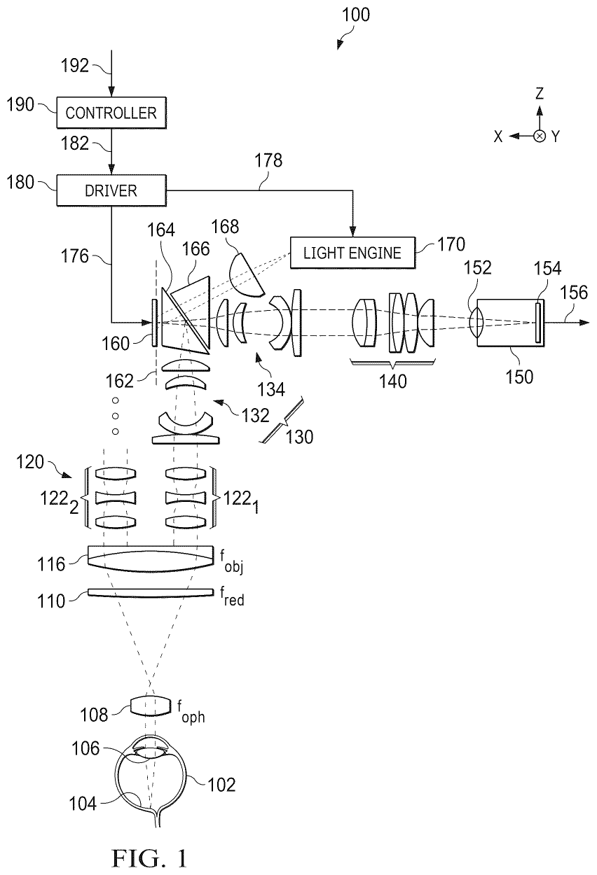

FIG. 1 is a block diagram illustrating an optical microscope 100 according to some examples. For illustration purposes and without any implied limitations, the optical microscope 100 is shown in FIG. 1 as being configured to image a retina 104 of a patient eye 102. In other configurations, the optical microscope 100 can similarly be configured to image other objects or organs.

In a representative example, the optical microscope 100 includes first and second eyepieces, only one of which (labeled 140) is explicitly shown in FIG. 1 for better clarity of depiction. The first eyepiece 140 is optically coupled to an objective lens 116 via a first portion 1221 of a magnification changer (zoom optics) 120 as indicated in FIG. 1. The second eyepiece (not explicitly shown) is nominally identical to the first eyepiece 140 and is similarly optically coupled to the objective lens 116 via a second portion 1222 of the magnification changer 120. The first and second eyepieces are typically arranged in a binocular head of the optical microscope 100 with their optical axes being substantially parallel to one another and spatially separated by a distance corresponding to the interpupillary distance of the user. In some examples, the binocular head of the optical microscope 100 enables the distance between the first and second eyepieces to be adjustable to compensate for interpupillary distance variations in different users and/or uneven vision.

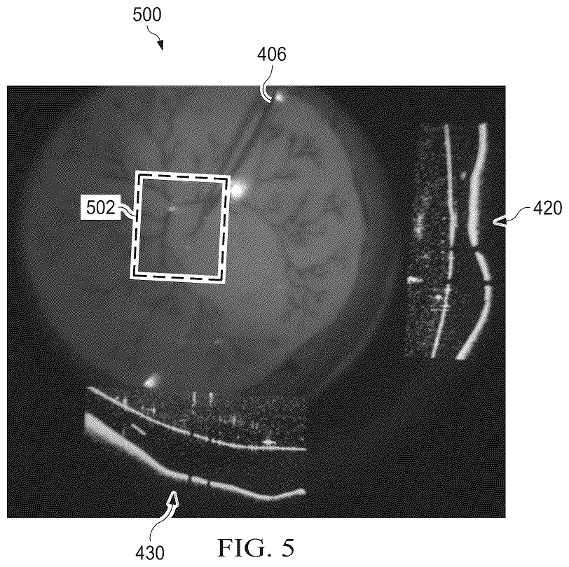

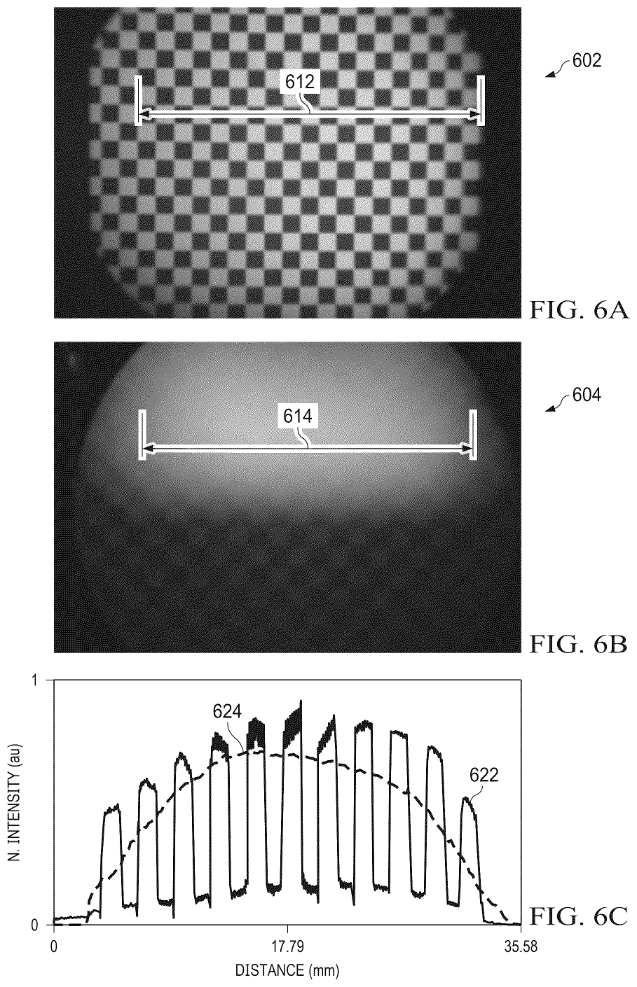

In the example shown, a user eye is modeled with a camera 150, which is optically coupled to the eyepiece 140 in a substantially similar manner. The camera 150 includes a lens 152 and a pixelated photodetector (e.g., a CCD) 154, which respectively model a typical crystalline lens and a typical retina of a human eye. As such, images captured by the pixelated photodetector 154 (e.g., see FIGS. 5, 6A) relatively accurately represent the images perceived by the user looking into the eyepiece 140. The captured images can be read out from the pixelated photodetector 154 in a conventional manner via a readout signal 156.

Different configurations of the optical microscope 100 may employ different embodiments of the eyepiece 140 characterized by different respective magnifications, such as 10×, 12.5×, 16×, 20×, etc. The choice of magnification typically depends on the needed size of the field of view and the desired overall magnification of the optical microscope 100. In some examples, the eyepiece 140 has a focal length of 125 mm.

The magnification changer 120 is designed to change the degree of magnification of the optical microscope 100 without any change in the working distance (i.e., the distance between the objective lens 116 and the patient eye 102). In the example shown, the magnification changer 120 includes a system of lenses, the relative position(s) of which can be controllably changed to provide a continuous change in the magnification. In one example, the changeable magnification provided by the magnification changer 120 can be in the range from 0.5× to 2.5×.

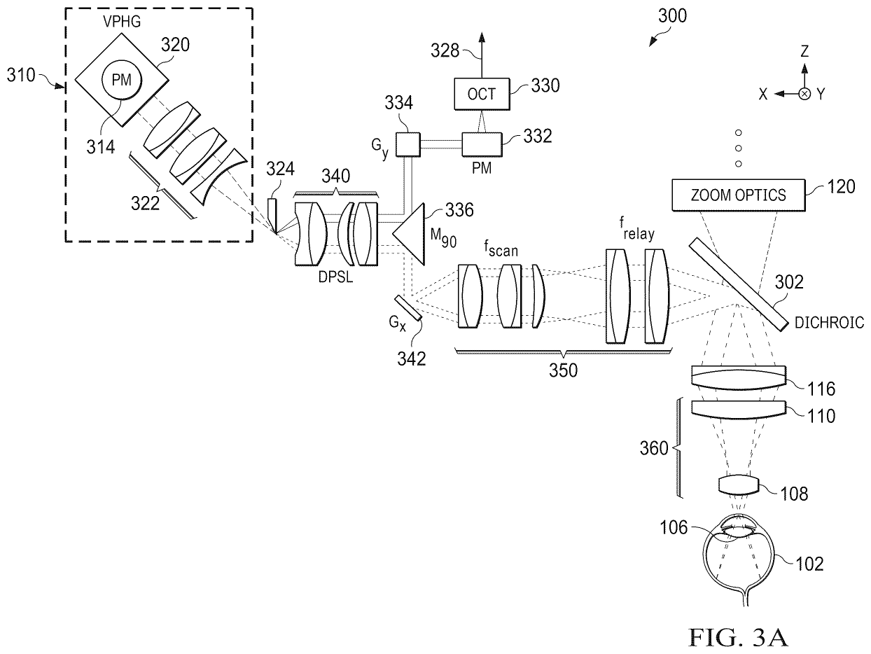

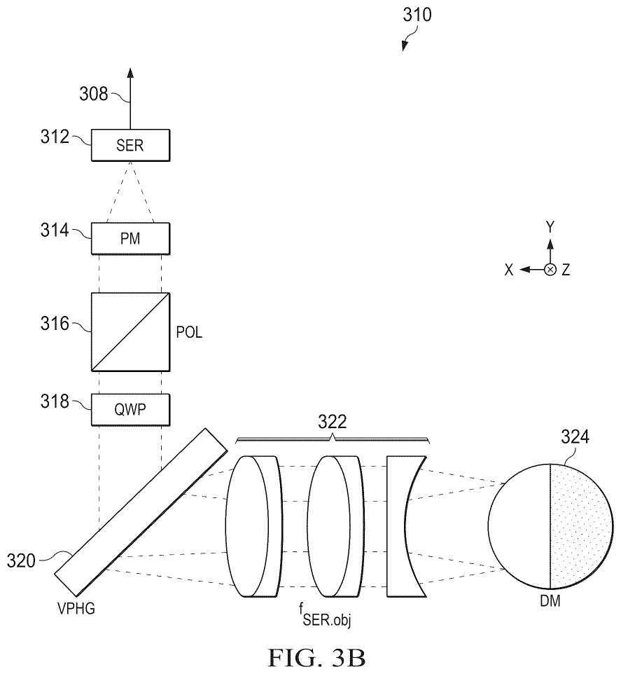

The objective lens 116 operates to direct the illumination light toward the patient eye 102 and to collect a portion of the illumination light reflected from the retina 104 (which may be referred to as object light). A reduction lens 110 and an ophthalmic lens 108 operate to reduce the beam dimeter and collimate the illumination light entering the patient eye 102 through a crystalline lens 106 thereof and further operate to properly couple the reflected light exiting the patient eye 102 through the crystalline lens 106 into the objective lens 116. The lenses 108, 110 further operate to increase the FOV of the optical microscope 100 (and of the volumetric imaging module 300, see FIG. 3A) on the retina 104. When the optical microscope 100 is used to image objects other than the patient eye 102, the reduction lens 110 and/or the ophthalmic lens 108 may be absent.

The illumination light is typically generated by an external illuminator (not explicitly shown in FIG. 1), e.g., a suitable light source that is installed away from the optical microscope 100 to avoid undesired heating of the microscope optics and/or of the surgical site. In various examples, the external illuminator may include a xenon light bulb, a halogen light bulb, an LED source, etc. In some examples, the light generated by the external illuminator is transmitted to the optical microscope 100 through a fiber guide and then passes through the objective lens 116 to illuminate the FOV. The illumination-light intensity can be varied by changing the voltage(s) applied to the light bulb(s) or LED source(s). While various designs of external illuminators are available, a preferred design for ophthalmic surgery provides for coaxial illumination. The coaxial illumination beneficially allows the illumination light to follow the same path as the object light to avoid shadows, which might occur with oblique illumination in some cases.

In various examples, the optical microscope 100 may use one of the following mechanical support systems: (i) on casters; (ii) wall mounted; (iii) tabletop; and (iv) ceiling mounted. In some cases, an on-caster stand is the preferred mechanical support structure owing to its better mobility. In some other cases, a ceiling or wall mount may be preferred because it helps with space management. An example mechanical support system for the optical microscope 100 may include precision motorized mechanics so that the microscope can be adjusted flexibly to the right position as needed. In some examples, the mechanical support system incorporates a foot pedal that can be used to control the illumination, focus, zoom, and X-Y position of the optics over the surgical field.

To enable overlays on the view observable through the eyepiece 140, the optical microscope 100 includes an optical relay 130, a 2D mirror array 160, a light engine 170, a driver circuit 180, and an electronic controller 190. The optical relay 130 may be optically coupled between the objective lens 116 and the eyepiece 140, e.g., as indicated in FIG. 1. In one example, the optical relay 130 is a 4F telecentric relay having a unity magnification and further having an intermediate focal plane 162 located between first and second relay portions 132, 134. The intermediate focal plane 162 is also conjugate to an object plane of the optical microscope 100. As a result, a sharp, focused image of the FOV can be formed at the intermediate focal plane 162. In a typical example, the relay portions 132, 134 have the same focal length F and are nominally identical, e.g., as indicated by the respective sets of lenses representing each of the relay portions 132, 134 in FIG. 1.

The 2D mirror array 160 is positioned such that the effective reflecting surface thereof is substantially located in the intermediate focal plane 162 of the optical relay 130. The optics of the optical relay 130 includes optical prisms 164, 166 optically coupled between the relay portions 132, 134 and the 2D mirror array 160 to achieve substantially (e.g., within ±5 degrees) normal incidence of the object light onto the 2D mirror array 160. Overlay light generated by the light engine 170 is collimated by a collimation lens 168 and is directed through the optical prisms 164, 166 to the 2D mirror array 160, e.g., as indicated in FIG. 1.

In one example, mirrors of the 2D mirror array 160 are arranged in mutually orthogonal rows and columns and have a pitch of 5.4 μm/pixel, with an overall size of the corresponding rectangular array being 1920×1080 pixel². In other examples, other pitches and overall sizes can also be used. The driver circuit 180 is configured to control the 2D mirror array 160 and the light engine 170 via control signals 176 and 178, respectively. In some examples, the control signals 176 and 178 can be synchronized to achieve a 60 Hz refresh rate (240 Hz per RGB color channel). In one example, the light engine 170 is implemented using the light engine Model DLPDLCR471TPEVM commercially available from Texas Instruments. In other examples, other suitable light engines or light sources can also be used as substitutes. For example, a fixed-spectrum LED source can be used when color control or color variability of the overlay light is not needed.

The electronic controller 190 is configured to provide a video signal 182 based on which the driver circuit 180 generates the control signals 176 and 178 for the 2D mirror array 160 and the light engine 170, respectively. In general, the video signal 182 can specify any pattern (e.g., including graphics, images, and/or text) to be overlayed onto the intraocular view observed through the eyepiece 140. In one example, the pattern specified by the video signal 182 includes one or more depth profiles (Z-coordinate information) of the patient eye 102 in the FOV of the optical microscope 100. In some examples, such depth profiles are computed by the electronic controller 190 or other suitable computing device based on the iOCT data received via a communication signal 192 from a volumetric imaging module 300 coupled to the optical microscope 100, e.g., as illustrated in FIGS. 3A-3B.

In some examples, the optical microscope 100 may further include a second set of elements analogous to the set including the optical relay 130, the 2D mirror array 160, the light engine 170, and the driver circuit 180. In such examples, such second set of elements is similarly installed in and coupled to the optical path between the second portion 1222 of the magnification changer 120 and the above-described second eyepiece of the binocular head of the optical microscope 100. The electronic controller 190 can similarly be used to control the driver circuit for the second set of elements, e.g., to beneficially enable stereoscopic overlays. In some examples, a shared 2D mirror array may be coupled to the two eyepieces such that a first portion of the shared 2D mirror array is configured to handle the intraocular overlay patterns for the first eyepiece, and a nonoverlapping second portion of the shared 2D mirror array is configured to handle the intraocular overlay patterns for the second eyepiece.

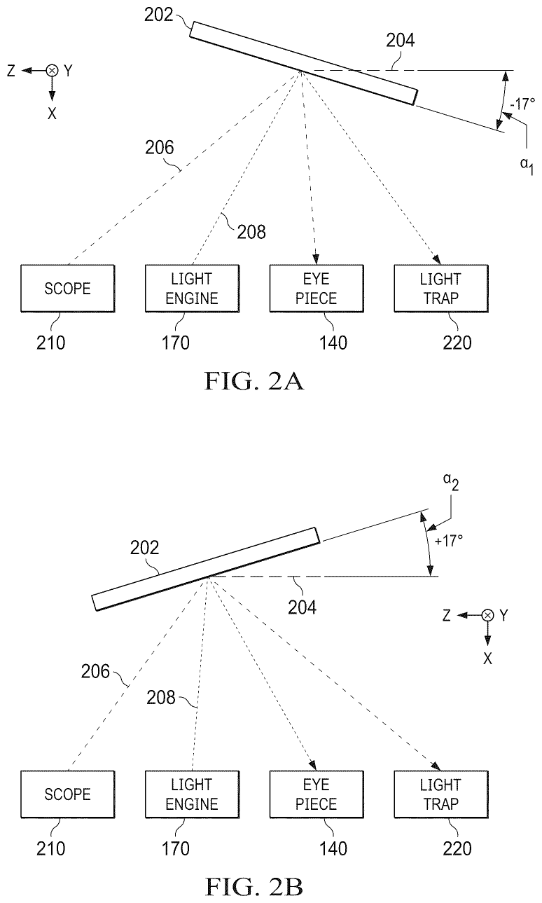

FIGS. 2A-2B are block diagrams illustrating optical configurations of the 2D mirror array 160 used in the optical microscope 100 according to some examples. More specifically, FIG. 2A illustrates a first orientation of an individual mirror 202 in the 2D mirror array 160 relative to a main plane 204 of the 2D mirror array 160 (which may be parallel to the substrate on which the 2D mirror array 160 is mounted and/or supported). FIG. 2B similarly illustrates a second orientation of the mirror 202 relative to the main plane 204. In the examples shown, the main plane 204 is parallel to the YZ coordinate plane (also see FIG. 1).

Herein, a “main plane” of an object, such as a die, a substrate, an IC, or a MEMS device, is a plane parallel to a substantially planar surface thereof that has about the largest area among the exterior surfaces of the object. This substantially planar surface may be referred to as a main surface. The exterior surfaces of the object that have one relatively large size, e.g., length, but are of much smaller area, e.g., less than one half of the main-surface area, are typically referred to as the edges of the object. A surface is considered to be substantially planar when the feature height variation along the surface is much smaller than the length of at least one of its edges.

Referring to FIG. 2A, in the first orientation, the mirror 202 is tilted by a first fixed rotation angle, α₁, with respect to the main plane 204. In the example shown, the angle α₁ is −17 degrees. When the mirror 202 is in the first orientation, a corresponding sub-beam 206 of the object light received from a scope 210 is reflected toward the eyepiece 140, whereas a corresponding sub-beam 208 of the overlay light received from the light engine 170 is directed to a light trap 220. Herein, the scope 210 is an optical assembly within the optical microscope 100 that includes the lenses 108, 110, and 116 and the magnification changer 120. The term “light trap” refers to a light sink that absorbs, dumps, captures, or stops substantially all of the light impinging thereon.

Referring to FIG. 2B, in the second orientation, the mirror 202 is tilted by a second fixed rotation angle, α₂, with respect to the main plane 204. In the example shown, the angle α₂ is +17 degrees. When the mirror 202 is in the second orientation, the corresponding sub-beam 206 of the object light received from the scope 210 is directed to the light trap 220, whereas the corresponding sub-beam 208 of the overlay light received from the light engine 170 is reflected toward the eyepiece 140.

When all of the individual mirrors 202 in the 2D mirror array 160 are in the respective first orientations, the eyepiece 140 displays an intraocular view of the FOV that is free of overlays. When mirrors in complementary first and seconds subsets of the mirrors 202 in the 2D mirror array 160 are in the first and second orientations, respectively, the eyepiece 140 displays an intraocular view of the FOV in which an overlay is present. The geometric shape of the overlay is determined by the geometric shape of the second subset of mirrors. The color pattern and brightness of the overlay are determined by the mixture, intensity, and gating of the primary (e.g., RGB) colors emitted by the light engine 170. Dynamic (i.e., time-dependent) overlay patterns are generated by changing the geometric shape of the second subset of mirrors in the 2D mirror array 160 and/or the mixture, intensity, and gating of the primary colors emitted by the light engine 170 by appropriately driving the 2D mirror array 160 and the light engine 170 using the drive circuit 180.

FIGS. 3A-3B are block diagrams illustrating a volumetric imaging module 300 coupled to the optical microscope 100 according to some examples. More specifically, FIG. 3A schematically illustrates a side view of the volumetric imaging module 300. FIG. 3B schematically illustrates a bottom view of a spectrally encoded reflectometry (SER) sub-module 310 of the volumetric imaging module 300. The XYZ coordinate triad shown in FIGS. 3A-3B has the same orientation as the XYZ coordinate triad shown in FIG. 1. In operation, the volumetric imaging module 300 enables both en face and cross-section imaging of the corresponding FOV. Herein, the term “cross-section imaging” refers to the cross section along the spatial dimension orthogonal to the en face FOV of the optical microscope 100. With the shown XYZ coordinate triad, an en face imaging plane is parallel to the XY coordinate plane, and a complementary “cross-sectional” dimension is parallel to the Z coordinate axis.

The volumetric imaging module 300 is designed and configured to perform spectrally encoded coherence tomography and reflectometry (SECTR), which combines cross-sectional swept-source optical-coherence-tomography (OCT) imaging with en face SER. This multimodality of the module 300 beneficially enables concurrent acquisition of en face reflectance images of regions-of-interest (ROI) motion at high-speed with inherently spatiotemporally co-registered volumetric OCT data. The utility of the SECTR methodology was previously demonstrated, e.g., for SER-based retinal-tracking and OCT motion-correction, multi-volumetric OCT mosaicking to extend the imaging FOV, multi-volumetric averaging to improve the OCT signal-to-noise ratio (SNR) and OCT angiography connectivity. Integrating the module 300 with the optical microscope 100 further beneficially enables the integrated instrument to generate real-time overlays, e.g., displaying co-registered cross sections of the corresponding en face FOV that can be observed by the user through at least the first eyepiece 140 or, in some embodiments, through both the first and second eyepieces of the binocular head of the optical microscope 100.

Referring to FIG. 3A, the volumetric imaging module 300 is coupled to the imaging optics of the optical microscope 100 using a dichroic filter (mirror) 302. In the example shown, the dichroic filter 302 is placed between the objective lens 116 and the magnification changer (zoom optics) 120 of the optical microscope 100 (also see FIG. 1). In one implementation, the dichroic filter 302 is substantially transparent to visible light and is highly (e.g., >90%) reflective to near infrared (NIR) light.

The volumetric imaging module 300 is configured to use NIR light generated by an external optical engine (not explicitly shown in FIG. 3A). In one example, the external optical engine includes a 400 kHz bidirectional 1051±46 nm swept laser. The optical output of this laser is power split approximately evenly into two optical portions, which are then directed to the SER sub-module 310 and an OCT sub-module 330, respectively, of the module 300. Example optical engines that can be used with the sub-modules 310 and 330 are described in more detail, e.g., in (1) Mohamed T. El-Haddad, Ivan Bozic, and Yuankai K. Tao, “Spectrally Encoded Coherence Tomography and Reflectometry (SECTR): simultaneous en face and cross-sectional imaging at 2 gigapixels-per-second,” J. Biophotonics, April 2018, Vol. 11(4): e201700268, 21 pages; and (2) Jacob J. Watson, Rachel Hecht, and Yuankai K. Tao, “Optimization of handheld spectrally encoded coherence tomography and reflectometry for point-of-care ophthalmic diagnostic imaging,” Journal of Biomedical Optics, July 2024, Vol. 29(7), 076006-(17 pages), both of which are incorporated herein by reference in their entirety.

Referring to both FIGS. 3A and 3B, the SER sub-module 310 includes a SER input/output block 312, a parabolic mirror (PM) 314, a linear polarizer (POL) 316, a quarter-wave plate (QWP) 318, a volumetric phase holographic grating (VPHG) 320, and a SER objective lens 322. SER illumination is collimated using the parabolic mirror 314 to maximize optical throughput. The linear polarizer 316 and the quarter wave plate 318 are used to implement circularly polarized SER illumination and cross-polarization detection. The optical beam impinging onto the VPHG 320 is spectrally dispersed thereby, and the resulting spectrally dispersed beam is focused by the telecentric SER objective lens 322 into a spectrally encoded line at the flat edge of a D-shaped pickoff mirror (DM) 324.

Referring to FIG. 3A, OCT illumination is collimated using an off-axis parabolic mirror (PM) 332 and then scanned by a slow-axis galvanometer (Gy) 334, reflected by a 90-degree prism mirror (M₉₀) 336, and focused at the DM 324 using a telecentric double-pass scan lens (DPSL) 340. The OCT and SER focused lines are combined across the DM 324 with minimal lateral offset to ensure overlapping SER and OCT FOVs. The downstream SER/OCT shared optics includes the DPSL 340, a fast-axis galvanometer (Gₓ) 342, a 5× magnifying 4F relay (f_{scan} to f_{relay}) 350, the dichroic filter 302, and a portion of the microscope optics including the lenses 116, 110, and 108. The 5× magnification of the relay 350 is used to compensate for the demagnification of the binocular indirect ophthalmo-microscope (BIOM) optics 110, 108 during posterior eye imaging.

The returned SER signal is detected in the SER input/output block 312 using an avalanche photodiode (APD, not explicitly shown). The electrical signal generated by the APD is converted into digital form using an analog-to-digital converter (ADC, not explicitly shown), and a resulting digital signal 308 (see FIG. 3B) is then directed to the electronic controller 190 for processing. The returned OCT signal is combined with the corresponding optical reference signal in the OCT sub-module 330, and the combined optical signal is detected using a balanced photodetector (BPD, not explicitly shown). The electrical signal generated by the BPD is converted into digital form using an ADC (not explicitly shown). A resulting digital signal 328 (see FIG. 3A) is then directed to the electronic controller 190 for processing. In some examples, the digital signals 308 and 328 are included as components in the above-described communication signal 192 (sec FIG. 1).

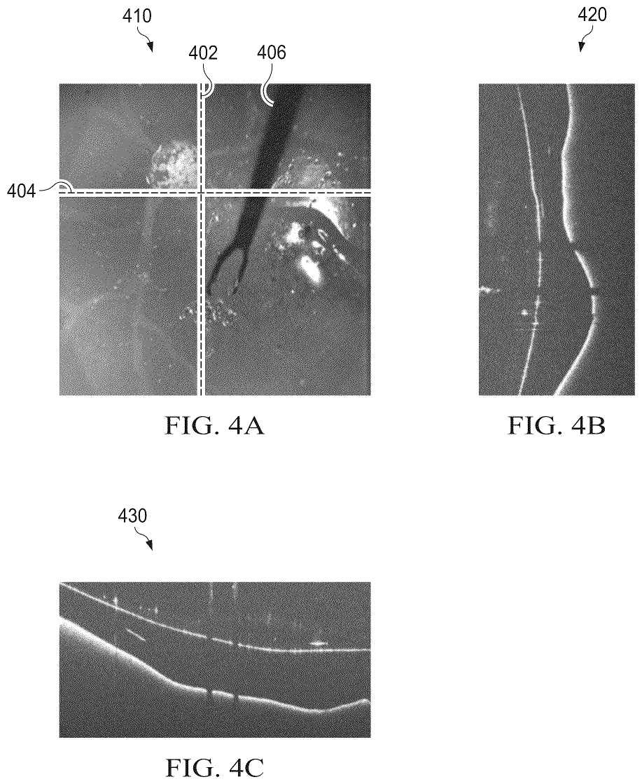

FIGS. 4A-4C pictorially illustrate volumetric imaging data acquired with the volumetric imaging module 300 according to one example. More specifically, FIG. 4A shows an en face reflectance image 410 of the model eye 102 acquired using the SER sub-module 310 of the volumetric imaging module 300. FIGS. 4B and 4C show cross-section images 420 and 430 of the model eye 102 acquired with the OCT sub-module 330 of the volumetric imaging module 300. Note that the cross-section images 420 and 430 correspond to cross-section planes 402 and 404, respectively, indicated in FIG. 4A. Also note that the en face reflectance image 410 includes an image of 25 G inner-limiting membrane forceps 406 located in the FOV above the model eye 102.

FIG. 5 pictorially illustrates an intraocular view 500 observed at the eyepiece 140 of the optical microscope 100 according to one example. The intraocular view 500 has been captured with the camera 150 and includes an overlay generated using the optical relay 130, the 2D mirror array 160, the light engine 170, the driver circuit 180, and the electronic controller 190 as described above in reference to FIGS. 1, 2A, and 2B. The overlay includes a bounding box 502 and the cross-section images 420 and 430 (also see FIGS. 4B, 4C). The bounding box 502 marks the location of the en face reflectance image 410 within the FOV of the optical microscope 100 (also see FIG. 4A). Also note that the FOV of the optical microscope 100 captures the forceps 406 (also see FIG. 4A).

FIGS. 6A-6C illustrate overlay-contrast improvements achieved with the optical microscope 100 according to some examples. More specifically, FIG. 6A shows an intraocular view 602 observed at the eyepiece 140 of the optical microscope 100 and including a binary checkerboard pattern overlaid onto the microscope view. FIG. 6B shows an intraocular view 604 observed at an eyepiece of another (functionally similar) optical microscope and including the same binary checkerboard pattern overlaid onto that microscope's view. The checkerboard pattern overlay for the view 604 is generated using an OLED display coupled across a beamsplitter cube substantially as described in Liangbo Shen, Oscar Carrasco-Zevallos, Brenton Keller, et al., “Novel microscope-integrated stereoscopic heads-up display for intrasurgical optical coherence tomography,” Biomedical Optics Express, 1 May 2016, Vol. 7, No. 5, pp. 1711-1726, which is incorporated herein by reference in its entirety. The top and bottom parts of the view 604 correspond to the microscope illumination light being on and off, respectively. FIG. 6C graphically shows intensity profile curves 622 and 624 corresponding to the views 602 and 604, respectively. More specifically, the intensity profile curve 622 represents the intensity profile along a line 612 in the view 602 (FIG. 6A), whereas the intensity profile curve 624 represents the intensity profile along a line 614 in the view 604 (FIG. 6B). Comparison of the intensity profile curves 622 and 624 readily demonstrates that the overlay contrast is significantly higher for the optical microscope 100 as compared to that in the other microscope, wherein the binary checkerboard pattern is barely visible under the same exposure time and with the microscope illumination light on or off.

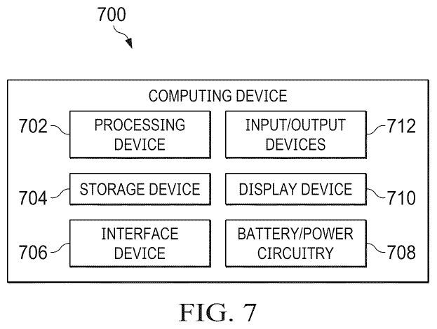

FIG. 7 is a block diagram illustrating a computing device 700 used with the optical microscope 100 according to some examples. In various examples, the optical microscope 100 may include or be communicatively coupled to a single computing device 700 or multiple computing devices 700. In some examples, the computing device 700 implements the electronic controller 190 (also see FIG. 1). In various examples, an instance of the computing device 700 can be used to implement data processing, image processing, video signal generation, and/or one or more instrument-control functions.

The computing device 700 of FIG. 7 is illustrated as having a number of components, but any one or more of these components may be omitted or duplicated, as suitable for the application and setting. In some embodiments, some or all of the components included in the computing device 700 may be attached to one or more motherboards and enclosed in a housing. In some embodiments, some of those components may be fabricated onto a single system-on-a-chip (SoC) (e.g., the SoC may include one or more electronic processing devices 702 and one or more storage devices 704). Additionally, in various embodiments, the computing device 700 may not include one or more of the components illustrated in FIG. 7, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 700 may not include a display device 710, but may include display device interface circuitry (e.g., a connector and driver circuitry) to which an external display device 710 may be coupled.

The computing device 700 includes a processing device 702 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 702 may include one or more digital signal processors (DSPs), application-specific integrated circuits (ASICs), central processing units (CPUs), graphics processing units (GPUs), server processors, field programmable gate arrays (FPGA), or any other suitable processing devices.

The computing device 700 also includes a storage device 704 (e.g., one or more storage devices). In various embodiments, the storage device 704 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 704 may include memory that shares a die with the processing device 702. In such an embodiment, the memory may be used as cache memory and include embedded dynamic random-access memory (eDRAM) or spin transfer torque magnetic random-access memory (STT-MRAM), for example. In some embodiments, the storage device 704 may include non-transitory computer readable media having instructions thereon that, when executed by one or more processing devices (e.g., the processing device 702), cause the computing device 700 to perform any appropriate ones of the methods disclosed herein below or portions of such methods.

The computing device 700 further includes an interface device 706 (e.g., one or more interface devices 706). In various embodiments, the interface device 706 may include one or more communication chips, connectors, and/or other hardware and software to govern communications between the computing device 700 and other computing devices. For example, the interface device 706 may include circuitry for managing wireless communications for the transfer of data to and from the computing device 700. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 706 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 706 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 706 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 706 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 706 may include one or more antennas (e.g., one or more antenna arrays) configured to receive and/or transmit wireless signals.

In some embodiments, the interface device 706 may include circuitry for managing wired communications, such as electrical, optical, or any other suitable communication protocols. For example, the interface device 706 may include circuitry to support communications in accordance with Ethernet technologies. In some embodiments, the interface device 706 may support both wireless and wired communication, and/or may support multiple wired communication protocols and/or multiple wireless communication protocols. For example, a first set of circuitry of the interface device 706 may be dedicated to shorter-range wireless communications such as Wi-Fi or Bluetooth, and a second set of circuitry of the interface device 706 may be dedicated to longer-range wireless communications such as global positioning system (GPS), EDGE, GPRS, CDMA, WiMAX, LTE, EV-DO, or others. In some other embodiments, a first set of circuitry of the interface device 706 may be dedicated to wireless communications, and a second set of circuitry of the interface device 706 may be dedicated to wired communications.

The computing device 700 also includes battery/power circuitry 708. In various embodiments, the battery/power circuitry 708 may include one or more energy storage devices (e.g., batteries or capacitors) and/or circuitry for coupling components of the computing device 700 to an energy source separate from the computing device 700 (e.g., to AC line power).

The computing device 700 also includes a display device 710 (e.g., one or multiple individual display devices). In various embodiments, the display device 710 may include any visual indicators, such as a heads-up display, a computer monitor, a projector, a touchscreen display, a liquid crystal display (LCD), a light-emitting diode display, or a flat panel display.

The computing device 700 also includes additional input/output (I/O) devices 712. In various embodiments, the I/O devices 712 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment of the optical microscope 100, various components of the interface devices 706 and/or I/O devices 712 can be configured to send and receive suitable control messages, suitable control/telemetry signals, and streams of data. In some examples, the interface devices 706 and/or I/O devices 712 include one or more analog-to-digital converters (ADCs) for transforming received analog signals into a digital form suitable for operations performed by the processing device 702 and/or the storage device 704. In some additional examples, the interface devices 706 and/or I/O devices 712 include one or more digital-to-analog converters (DACs) for transforming digital signals provided by the processing device 702 and/or the storage device 704 into an analog form suitable for being communicated to the corresponding components of the optical microscope 100.

According to an example embodiment disclosed above, e.g., in the summary section and/or in reference to any one or any combination of some or all of FIGS. 1-7, provided is an apparatus comprising: a first optical relay coupled between an objective lens and a first eyepiece of an optical microscope, the first optical relay having an intermediate focal plane between first and second relay portions thereof; a first 2D mirror array having at least a first portion thereof in the intermediate focal plane of the first optical relay; a light source configured to illuminate the first 2D mirror array with overlay light; and a driver circuit configured to controllably switch each mirror of the first 2D mirror array between a respective first orientation and a respective second orientation, wherein, in the respective first orientation, a mirror of the first 2D mirror array is configured to: direct object light from the objective lens toward the first eyepiece; and direct the overlay light from the light source toward a light trap; and wherein, in the respective second orientation, the mirror of the first 2D mirror array is configured to: direct the object light from the objective lens toward the light trap; and direct the overlay light from the light source toward the first eyepiece.

In some embodiments of the above apparatuses, the intermediate focal plane is conjugate to an object plane of the optical microscope.

In some embodiments of any of the above apparatuses, the first optical relay is a 4F telecentric relay having a unity magnification. In some other embodiments, other suitable types of optical relays can also be used, including optical relays configured to provide magnification/demagnification factors that are different from unity magnification, i.e., that are greater or smaller than one.

In some embodiments of any of the above apparatuses, the first relay portion of the first optical relay comprises a 2F optical relay; and wherein the second relay portion of the first optical relay comprises another 2F optical relay.

In some embodiments of any of the above apparatuses, optical axes of the first and second relay portions are substantially orthogonal to one another.

In some embodiments of any of the above apparatuses, the apparatus further comprises an optical prism coupled between the first and second relay portions of the first optical relay to achieve substantially (e.g., within 10 degrees) normal incidence of the object light onto a main plane of the first 2D mirror array. In some examples, the optical prism is designed and configured to have optical properties that enable the optical prism substantially not to add chromatic aberration to either the optical microscope or the projected light paths. This particular optical property can be conferred, e.g., by specific tuning of the angles of the prism components and their indices of refraction. In a preferred configuration, the optical prism provides total internal reflection (TIR) for the object light at the first glass-air interface and does not cause TIR at the same interface after the DMD.

In some embodiments of any of the above apparatuses, the apparatus further comprises a camera optically coupled to the first optical relay to capture at least a portion of the object light and at least a portion of the overlay light directed by the first 2D mirror array toward the first eyepiece.

In some embodiments of any of the above apparatuses, the apparatus further comprises an ophthalmic lens configured to direct the object light toward the first eyepiece through the objective lens and the first optical relay.

In some embodiments of any of the above apparatuses, the overlay light generated by the light source has a fixed, time-independent optical spectrum.

In some embodiments of any of the above apparatuses, the light source comprises a color light engine.

In some embodiments of any of the above apparatus, the driver circuit is configured to drive the first 2D mirror array and the color light engine in response to a received input signal specifying an overlay pattern to be projected toward the first eyepiece.

In some embodiments of any of the above apparatuses, the received input signal is a video signal.

In some embodiments of any of the above apparatuses, the apparatus further comprises a dichroic mirror optically coupled between the objective lens and the first optical relay and configured to optically couple a volumetric imaging module to imaging optics of the optical microscope.

In some embodiments of any of the above apparatuses, the volumetric imaging module is configured to OCT imaging.

In some embodiments of any of the above apparatuses, the volumetric imaging module is further configured to perform SER imaging.

In some embodiments of any of the above apparatuses, the driver circuit is configured to drive the first 2D mirror array to cause an overlay pattern projected toward the first eyepiece to include an OCT image acquired using the volumetric imaging module.

In some embodiments of any of the above apparatuses, the apparatus further comprises a second optical relay coupled between the objective lens and a second eyepiece of the optical microscope, the second optical relay having a respective intermediate focal plane between a respective first relay portion and a respective second relay portion thereof, wherein the first 2D mirror array has at least a second portion thereof in the respective intermediate focal plane of the second optical relay. In some examples, the first and second portions of the 2D mirror array are separately configured to allow display of different respective images in the first and second eyepieces. In some examples, the different respective images are such that a stereoscopic overlay is created for the viewer.

In some embodiments of any of the above apparatuses, the apparatus further comprises: a second optical relay coupled between the objective lens and a second eyepiece of the optical microscope, the second optical relay having a respective intermediate focal plane between a respective first relay portion and a respective second relay portion thereof; and a second 2D mirror array in the respective intermediate focal plane of the second optical relay. In some examples, the first and second 2D mirror arrays are separately configured to allow display of different respective images in the first and second eyepieces. In some examples, the different respective images are such that a stereoscopic overlay is created for the viewer.

In some embodiments of any of the above apparatuses, the apparatus further comprises a second light source configured to illuminate the second 2D mirror array with second overlay light, wherein the driver circuit is further configured to controllably switch each mirror of the second 2D mirror array between a corresponding first orientation and a corresponding second orientation; wherein, in the corresponding first orientation, a mirror of the second 2D mirror array is configured to: direct the object light from the objective lens toward the second eyepiece; and direct the second overlay light from the second light source toward the light trap; and wherein, in the corresponding second orientation, the mirror of the second 2D mirror array is configured to: direct the object light from the objective lens toward the light trap; and direct the second overlay light from the second light source toward the second eyepiece.

According to another example embodiment disclosed above, e.g., in the summary section and/or in reference to any one or any combination of some or all of FIGS. 1-7, provided is a method of generating an intraocular overlay pattern in an optical microscope, the method comprising: illuminating a 2D mirror array with overlay light, the 2D mirror array having at least a portion thereof in an intermediate focal plane of an optical relay coupled between an objective lens and an eyepiece of the optical microscope; and controllably rotating each mirror of the 2D mirror array into a respective first orientation or a respective second orientation, wherein, in the respective first orientation, a mirror of the 2D mirror array is configured to: direct object light from the objective lens toward the eyepiece; and direct the overlay light toward a light trap; and wherein, in the respective second orientation, the mirror of the 2D mirror array is configured to: direct the object light from the objective lens toward the light trap; and direct the overlay light toward the eyepiece. In some examples, the overlay opacity and/or color(s) can be tuned as needed by using the pulse-width-modulation control of the corresponding light engine (e.g., 170, FIG. 1) and/or by adjusting the configuration of the 2D mirror array (e.g., 160, FIG. 1).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The modifier “about” or “approximately” used in connection with a quantity is inclusive of the stated value and has the meaning dictated by the context (for example, it includes at least the degree of error associated with the measurement of the particular quantity). The modifier “about” or “approximately” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example, “about 1” may also mean from 0.5 to 1.4.

“SUMMARY” in this specification is intended to introduce some example embodiments, with additional embodiments being described in “DETAILED DESCRIPTION” and/or in reference to one or more drawings. “SUMMARY” is not intended to identify essential elements or features of the claimed subject matter, nor is it intended to limit the scope of the claimed subject matter.

What is claimed is:

1. An optical microscope, comprising:
a first optical relay coupled between an objective lens and a first eyepiece of the optical microscope, the first optical relay having an intermediate focal plane between first and second relay portions thereof;
a first two-dimensional (2D) mirror array having at least a first portion thereof in the intermediate focal plane of the first optical relay;
a light source configured to illuminate the first 2D mirror array with overlay light; and
a driver circuit configured to controllably switch each mirror of the first 2D mirror array between a respective first orientation and a respective second orientation,
wherein, in the respective first orientation, a mirror of the first 2D mirror array is configured to:
direct object light from the objective lens toward the first eyepiece; and
direct the overlay light from the light source toward a light trap; and
wherein, in the respective second orientation, the mirror of the first 2D mirror array is configured to:
direct the object light from the objective lens toward the light trap; and
direct the overlay light from the light source toward the first eyepiece.

2. The optical microscope of claim 1, wherein the intermediate focal plane is conjugate to an object plane of the optical microscope.

3. The optical microscope of claim 1, wherein the first optical relay is a 4F telecentric relay having a unity magnification.

4. The optical microscope of claim 3,
wherein the first relay portion of the first optical relay comprises a 2F optical relay; and
wherein the second relay portion of the first optical relay comprises another 2F optical relay.

5. The optical microscope of claim 1, wherein optical axes of the first and second relay portions are substantially orthogonal to one another.

6. The optical microscope of claim 5, further comprising an optical prism coupled between the first and second relay portions of the first optical relay to achieve substantially normal incidence of the object light onto a main plane of the first 2D mirror array.

7. The optical microscope of claim 1, further comprising a camera optically coupled to the first optical relay to capture at least a portion of the object light and at least a portion of the overlay light directed by the first 2D mirror array toward the first eyepiece.

8. The optical microscope of claim 1, further comprising an ophthalmic lens configured to direct the object light toward the first eyepiece through the objective lens and the first optical relay.

9. The optical microscope of claim 1, wherein the overlay light generated by the light source has a fixed, time-independent optical spectrum.

10. The optical microscope of claim 1, wherein the light source comprises a color light engine.

11. The optical microscope of claim 10, wherein the driver circuit is configured to drive the first 2D mirror array and the color light engine in response to a received input signal specifying an overlay pattern to be projected toward the first eyepiece.

12. The optical microscope of claim 11, wherein the received input signal is a video signal.

13. The optical microscope of claim 1, further comprising a dichroic filter optically coupled between the objective lens and the first optical relay and configured to optically couple a volumetric imaging module to imaging optics of the optical microscope.

14. The optical microscope of claim 1, wherein the volumetric imaging module is configured to perform optical coherence tomography (OCT) imaging.

15. The optical microscope of claim 14, wherein the volumetric imaging module is further configured to perform spectrally encoded reflectometry (SER) imaging.

16. The optical microscope of claim 14, wherein the driver circuit is configured to drive the first 2D mirror array to cause an overlay pattern projected toward the first eyepiece to include an OCT image acquired using the volumetric imaging module.

17. The optical microscope of claim 1, further comprising a second optical relay coupled between the objective lens and a second eyepiece of the optical microscope, the second optical relay having a respective intermediate focal plane between a respective first relay portion and a respective second relay portion thereof,
wherein the first 2D mirror array has at least a second portion thereof in the respective intermediate focal plane of the second optical relay.

18. The optical microscope of claim 1, further comprising:
a second optical relay coupled between the objective lens and a second eyepiece of the optical microscope, the second optical relay having a respective intermediate focal plane between a respective first relay portion and a respective second relay portion thereof; and
a second 2D mirror array in the respective intermediate focal plane of the second optical relay.

19. The optical microscope of claim 18, further comprising a second light source configured to illuminate the second 2D mirror array with second overlay light,
wherein the driver circuit is further configured to controllably switch each mirror of the second 2D mirror array between a corresponding first orientation and a corresponding second orientation;
wherein, in the corresponding first orientation, a mirror of the second 2D mirror array is configured to:
direct the object light from the objective lens toward the second eyepiece; and
direct the second overlay light from the second light source toward the light trap; and
wherein, in the corresponding second orientation, the mirror of the second 2D mirror array is configured to:
direct the object light from the objective lens toward the light trap; and
direct the second overlay light from the second light source toward the second eyepiece.

20. A method of generating an intraocular overlay pattern in an optical microscope, the method comprising:
illuminating a two-dimensional (2D) mirror array with overlay light, the 2D mirror array having at least a portion thereof in an intermediate focal plane of an optical relay coupled between an objective lens and an eyepiece of the optical microscope; and
controllably rotating each mirror of the 2D mirror array into a respective first orientation or a respective second orientation,
wherein, in the respective first orientation, a mirror of the 2D mirror array is configured to:
direct object light from the objective lens toward the eyepiece; and
direct the overlay light toward a light trap; and
wherein, in the respective second orientation, the mirror of the 2D mirror array is configured to:
direct the object light from the objective lens toward the light trap; and
direct the overlay light toward the eyepiece.
